(19) United States
(12) Patent Application Publication
(10) Pub. No.: US 2017/0248434 A1
(43) Pub. Date: Aug. 31, 2017

(54) CAR-TOP MOUNT WITH POPULATION DENSITY ESTIMATION

(71) Applicant: Blake Dearring Best, Cincinnati, OH (US)

(72) Inventor: Blake Dearring Best, Cincinnati, OH (US)

(21) Appl. No.: 15/445,045

(22) Filed: Feb. 28, 2017

Related U.S. Application Data
(60) Provisional application No. 62/301,064, filed on Feb. 29, 2016.

(51) Int. Cl. G01C 21/34; H04N 7/18; G06K 9/00; G01S 19/13

(52) U.S. Cl. CPC G01C 21/3453; G01C 21/3415; G01S 19/13; H04N 7/185; G06K 9/00791

(57) ABSTRACT

In many contexts, vehicles navigate routes while providing a service on behalf of a service provider, and with the assistance of global positioning systems (GPS) for navigation, routing, and/or vehicle tracking. In addition to identifying the location of the vehicle, devices with integrated GPS may also identify a population density (e.g., of individuals, cyclists, or other vehicles) within a vicinity of a location of the vehicle, which may caution a driver of high-population-density areas; may be used to assess a risk of the vehicle while navigating the route, and/or to suggest alternative routes; and/or to count the people who observe the vehicle navigating the route while performing the service. The GPS and/or population density estimator (e.g., a camera) are integrated with a car topper that is mounted atop the vehicle with a display that identifies the service, and optionally with a reversible mounting attachment and/or an integrated high-gain antenna.

### CROSS-REFERENCE TO RELATED APPLICATIONS

This application claims priority under 35 U.S.C. §119(e) to Provisional U.S. Patent Application No. 62/301,064, filed on Feb. 29, 2016, the entirety of which is hereby incorporated by reference as if fully rewritten herein.

### BACKGROUND

Within the field of navigation, many scenarios involve vehicle navigation devices with global positioning system (GPS) receivers. Such receivers are typically mounted within and/or positioned on a dashboard, and provide navigation assistance to a driver while traveling a route on behalf of a service. Vehicular GPS receivers are also provided to track the location of the vehicle, such as a truck fleet while providing long-distance freight service, or a food or mail delivery vehicle to track the progress of deliveries and/or estimate an arrival at a particular location.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While GPS-based vehicle tracking is often utilized to enable tracking of the location, route, and/or progress of the vehicle and/or to assist a driver in navigating the route while providing the service, it may be additionally useful to identify a population density of a population of pedestrians, cyclists, vehicles, etc. within a vicinity of the location of the vehicle while traveling the route. For instance, alerting a driver of a high-density population in the vicinity of the vehicle may enable the driver to slow down and/or be more watchful to avoid collisions, and/or may enable a navigation system to identify an alternative route with a lower population density to recommend to the driver. Such population density estimates may be useful, e.g., to promote the safety of the vehicle, the driver, and/or the members of the population, and/or to facilitate the navigation of the vehicle along the route while providing the service. Such population density estimates may also be useful to enable a live and/or retrospective analysis to determine the population encountered by the vehicle while providing the service, such as the safety thresholds of providing the service using the vehicle at various times of day; the number of individuals who have seen the vehicle and a car-top display that identifies the service; and/or the number of individuals who patronize the vehicle while providing the service, such as the number of people who choose to ride a bus or a train.

Presented herein are devices that enable the estimation of vehicle population densities in the vicinity of the vehicle during navigation of a route to provide the service. The devices comprise a car-top mount with an integrated global positioning system (GPS) receiver, and a population density estimator that estimates the population density within the vicinity of the location of the vehicle. For example, the population density estimator may comprise a camera that periodically captures an image of the vicinity of the vehicle, and an image evaluator that counts the population (e.g., individuals, cyclists, and/or vehicles) appearing in the image. The device further comprises population density reporter that reports the population density to the service provider of the vehicle during the route while providing the service. The integration of such components with a car-top mount may be advantageous, e.g., for providing a high vantage point with significant visibility; for integrating a high-gain antenna that is both external to the vehicle, thereby facilitating reception of the GPS radiofrequency and/or a cellular signal to communicate with the service provider, and also at least partially protected from wind and weather; and/or for providing a convenient, integrated, removable apparatus that also identifies the service provided by the vehicle.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring a global positioning system (GPS) navigation system usable to facilitate a driver of a vehicle in navigating a route.

FIG. 2 is an illustration of an example scenario featuring a global positioning system (GPS) navigation system usable to estimate a population density of a vicinity of a location of a vehicle while navigating a route, in accordance with the techniques presented herein.

FIG. 3 is an illustration of an example device and/or system that estimates a population density of a vicinity of a location of a vehicle while navigating a route, in accordance with the techniques presented herein.

FIG. 4 is an illustration of an example method of estimating a population density of a vicinity of a location of a vehicle while navigating a route, in accordance with the techniques presented herein.

FIG. 5 is an illustration of an example computer-readable memory device that causes a device to estimate a population density of a vicinity of a location of a vehicle while navigating a route, in accordance with the techniques presented herein.

FIG. 6 is an illustration of an example scenario featuring techniques for estimating a population density of a vicinity of a location of a vehicle while navigating a route, in accordance with the techniques presented herein.

FIG. 7 is an illustration of another example scenario featuring techniques for estimating a population density of a vicinity of a location of a vehicle while navigating a route, in accordance with the techniques presented herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

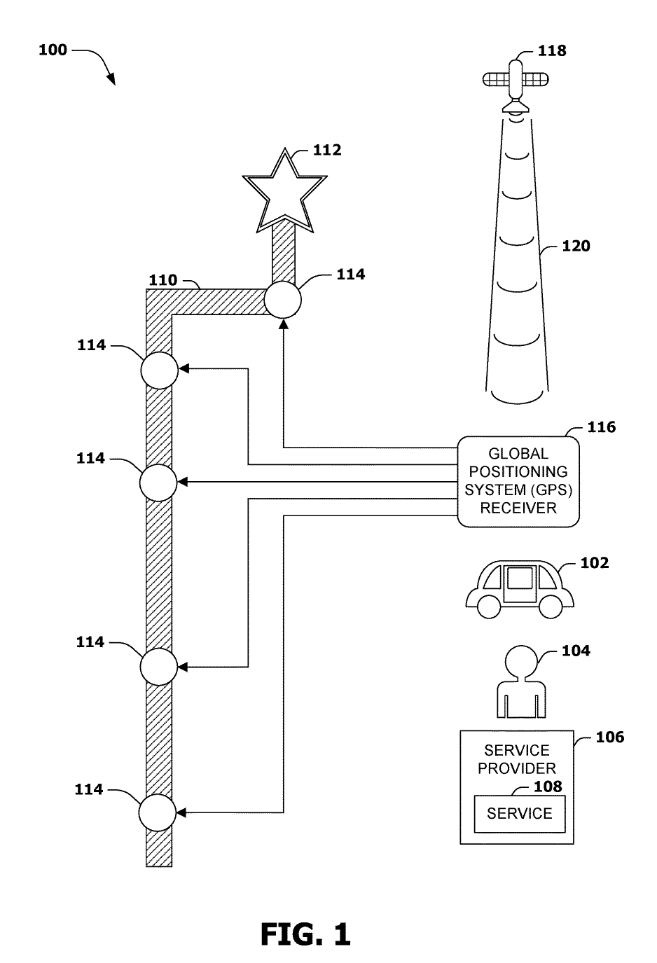

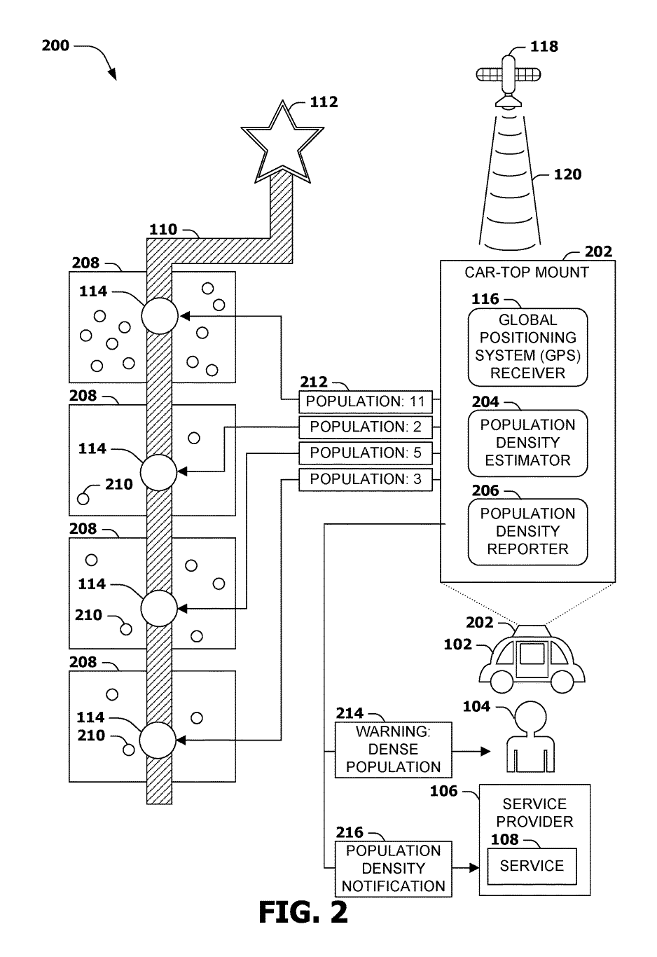

FIG. 1 is an illustration of an example scenario 100 featuring a vehicle 102 navigated by a driver 104 along a route 110 to a destination 112 while providing a service 108 on behalf of a service provider 106. In this example scenario 100, the driver 104 may be a courier of a product of the service 108, such as a package and/or food delivery service 108, or a transportation vehicle 102, such as a bus or train. The driver 104 operates the vehicle 102 along a route 110 to a destination 112, such as the delivery point or a terminal of the transportation service 108.

To facilitate the navigation of the route 110, the driver 104 may utilize a global positioning system (GPS) receiver 116 that communicates with an array of geostationary satellites 118 via radiofrequency 120 to triangulate and identify a location 114 of the vehicle 102. The location 114 of the vehicle 102 is often usable, e.g., to assist the driver 104 in navigating the route 110, such as displaying a map and/or providing navigation instructions for navigating the vehicle 102 to reach the destination 112. Such GPS receivers 116 may also be usable to track the location 114 of the vehicle 102 for reporting to the service provider 106, e.g., in order to update the service provider 106 of the progress of the vehicle 102 along the route 110 and/or the estimated arrival of the vehicle 102 at the destination 112. For example, the GPS receiver 116 may be integrated with a dash-mounted navigation system of the vehicle 102 that presents navigation in formation in a dashboard-mounted display and/or integrates with an audio system of the vehicle 102; a portable navigation device that the driver 104 may affix to a dashboard of the vehicle 102; and/or a mobile phone or tablet of the driver 104 that may double as a navigation device for the vehicle 102. In this manner, the GPS receiver 116 facilitates the user 104 in the navigation of the vehicle 102.

### B. Presented Techniques

While the use of a device with a GPS receiver 116 may be usable to facilitate the driver 104 in navigating the route 110 toward the destination 112, some information about the route 110 of the vehicle 102 may not be directly detected and/or measured by such devices that may facilitate the traversal of the route 110 by the vehicle 102. In particular, it is noted that as the vehicle 102 navigates the route 110, the vehicle 102 may encounter a population of individuals 210 within a vicinity 208 of the location 114 of the vehicle 102, such as pedestrians, cyclists, and/or other vehicles that are within a visible range of the vehicle 102. The population density of the individuals 210 within the vicinity 208 of the vehicle 102 may represent significant information for several reasons. For example, the population density may represent a safety risk to the vehicle 102 and/or driver 104, e.g., a collision risk that warrants greater attention by the driver 104 while navigating the vehicle 102 as compared with locations 114 along the route 110 that are sparsely populated. Such safety risk may also be conveyed to the service provider 106 to inform a concurrent and/or retrospective analysis of the risk of the vehicle 102 and/or driver 104 while navigating this particular route 110 through various locations 114 to the destination 112 while providing the service 108 on behalf of the service provider 106.

Additionally, in such scenarios, drivers 104 of such vehicles 102 often utilize a car-top mount 202 that includes various information, such as a car-top display that identifies the service 108 provided by the vehicle 102 (e.g., the name, logo, and/or contact information of the service provider 106). For example, a transportation service provider 106 may provide car-top mounts 202 that a driver 104 may affix to the top of the vehicle 102 (optionally in a removable manner, e.g., using a magnetic mount attachment) to display the name and/or type of the transportation service 108, such as identifying the vehicle 102 as a taxi and the in-service status of the vehicle 102. A delivery service 108 may utilize car-top mounts 202 that identify the delivery service provider 106 in order to inform recipients of the service at the destination 112 of the arrival of the vehicle 102.

In view of such observations, the example scenario 200 provides a car-top mount 202 that is attachable, optionally with a reversible mount attachment, to the top of the vehicle 102. The car-top mount 202 comprises an integrated GPS receiver 116 that communicates with an array of geostationary satellites 118 via radiofrequency 120 to determine a location 114 of the vehicle 102 along the route 110 toward the destination 112. Additionally, the car-top mount 202 further comprises a population density estimator 204, which estimates a population density estimate 212 of a population 210 in a vicinity 208 of the location 114 of the vehicle 102 during the route 110, such as an estimated count of individuals, cyclists, and/or other vehicles that are within visible range of the vehicle 102. The car-top mount 202 further comprises a population density reporter 206, which reports the population density estimate 212 to the service provider 106 of the vehicle 102 during the route 110 while providing the service 108 (e.g., transmitting a population density notification 216 to deliver to the service provider 106 either promptly or at a later time), and/or presents a population density alert 214 to the driver 104 when the population density estimate 212 exceeds a first threshold indicating a dense population that warrants greater caution. In this manner, the elements of the car-top mount 202 interoperate to collect and report population density estimates 212 within the vicinity 208 of the locations 114 of the vehicle 102 while traveling the route 110 during the provision of the service 108, in accordance with the techniques presented herein.

### C. Technical Effects

Various uses of the techniques presented herein may result in a variety of technical effects.

A first technical effect provided by the techniques presented herein involves the integration of the global positioning system (GPS) receiver 116 and the population density estimator 204 with the car-top mount 202. As a first such example, the integration of such elements in a car-top mount 202 may promote the functionality thereof. For example, the GPS receiver 116 may feature a high-gain antenna that is integrated with the car-top mount 202 and that is therefore in greater contact with the array of GPS satellites 118 to track the location 114 of the vehicle 102 more accurately than a miniaturized antenna of a portable device within the interior of the vehicle 102. Additionally, a population density estimator 204 that is integrated with a car-top mount 202 may have a high vantage point of the vicinity 208 of the location 114 of the vehicle 102. For example, a device such as camera mounted atop the vehicle 102 in a car-top mount 202 may have better visibility of the individuals 210 within the vicinity 208 of the location 114 of the vehicle 102, which may not be as visible from within the interior of the vehicle 102 (including to the driver 104 of the vehicle). The integration of the population density estimator 204 with the car-top mount 202 may therefore promote the accuracy of the population density estimates 212 determined by the population density estimator 204.

A second technical effect that may be achievable through the techniques presented herein is the synergistic integration of devices that interoperate to assist the vehicle 102 and/or the service provider 106 in the provision of the service 108. For example, drivers 104 of vehicles 102 often utilize car-top mounts 202 while providing services 108 on behalf of a service provider 106. The integration of the GPS receiver 116 and population density estimator 204 may therefore present a convenient package of functionality that is usable together; e.g., by attaching the car-top mount 202 to the top of the vehicle 102, the driver 104 and/or service provider 106 collect and receive both the tracking of locations 114 and the population density estimates 212 continuously through the use of the vehicle 102 to navigate the route 110 and provide the service 108. This convenience may exceed that, e.g., of integrating such components with a mobile phone or device of the driver 104, which, as a multipurpose device, may be carried away by the driver 104 upon exiting the vehicle 104. Additionally, some car-top mounts 202 also utilize a power source (e.g., an integrated battery and/or a connection to a power source of the vehicle 102), such as for illumination. Integrating the global positioning system (GPS) receiver 116 and the population density estimator 204 may enable such devices to utilize the same power source as the car-top mount 202 (e.g., connecting the power connector of the car-top mount 202 may also power the GPS receiver 116 and/or the population density estimator 204), which may be more convenient than non-integrated devices that are powered by separate power sources (e.g., separate batteries that have to be charged individually and/or connected to power sources with separate power cables). Additionally, as car-top mounts 202 are already designed to be weatherproof and securely mountable to the top of the vehicle 102, the integration of the GPS receiver 116 and/or population density estimator 204 with the car-top mount 202 may enable such devices to be affixed to the exterior of the vehicle 102 without requiring such devices to feature weatherproofing housing and/or device attachment to attach to the vehicle 102 to protect the devices from conditions such as wind and weather.

A third technical effect provided by the techniques presented herein involves the uses of the population density estimates 212 collected by the population density estimator 204 and reported by the population density reporter 206. As a first such example, the population density estimates 212 may promote the safe operation of the vehicle 102, e.g., by enabling the presentation of a population density alert 214 to the driver 104 upon entering a population-dense area that draws the attention of the driver 104 to the proximity of individuals 210 to the vehicle 102, thus enabling the driver 104 to avoid a collision. As a second such example, the population density estimates 212 may enable the service provider 106 to assess (concurrently and/or retrospectively) the safety of the route 110 of the vehicle 102 to the destination 112 (e.g., a determination of the risk of the vehicle 102 and/or driver 104 in following this particular route 110). If the safety risk is assessed to be too high, the service provider 106 may instruct the vehicle 102 and/or driver 104 to take an alternate route to the destination 112, such as a different road that is projected to present a typically lower population density of individuals 210, and therefore a reduced safety risk in navigating to the destination 112. As a third such example, the reporting of population density estimates 212 may assist in the navigation of the route 110 to the destination 112 (e.g., enabling a navigation system to identify and recommend an alternative route that may avoid a high population density), and/or may enable the driver 104 and/or service provider 106 to estimate an arrival time of the vehicle 102 at the destination 112 (e.g., extending an estimated arrival time while the vehicle 102 is navigating through locations 114 of high population density, due to the added caution, slower speed, and/or localized traffic congestion created by the population density of individuals 210). As a fourth such example, the reporting of population density estimates 212 may enable an identification of the number of individuals 210 who have seen the vehicle 102 and a car-top display that identifies the service 108 during the navigation of the route 110. As a fifth such example, the reporting of population density estimates 212 may enable an estimate of a count of individuals 210 who patronize the vehicle 102 while providing the service 108, such as the number of people who choose to ride a bus or a train. Many such technical effects are achievable through embodiments of the techniques presented herein.

### D. Example Embodiments

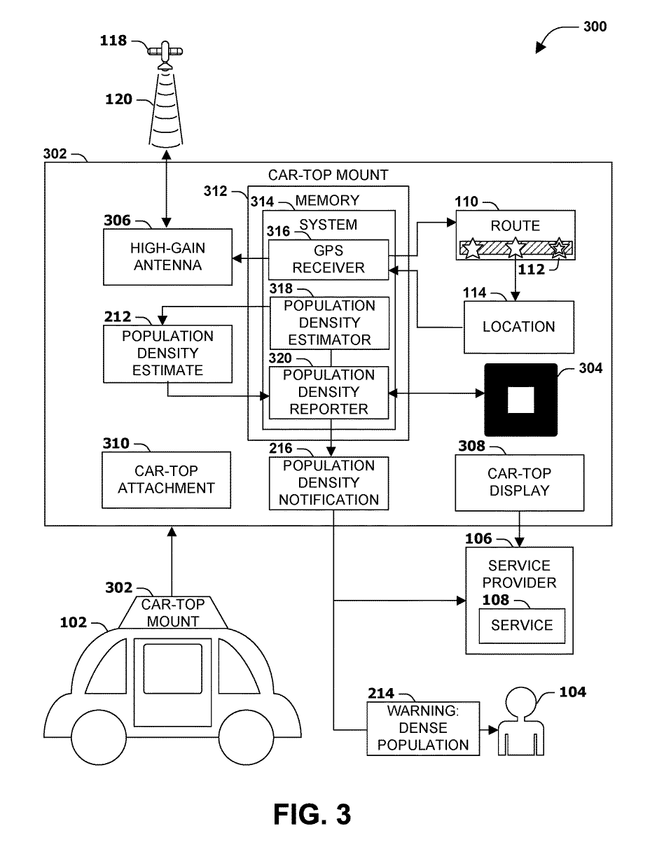

FIG. 3 is an illustration of an example scenario 300 featuring some various embodiments of the techniques presented herein.

The example scenario 300 of FIG. 3 involves a car-top mount 302 that is mountable atop a vehicle 102 operated by a driver 104 while navigating a route 110 to a destination 112. The car-top mount 302 comprises a car-top attachment 310, such as an array of magnets that removably affixes the car-top mount 302 to the top of the vehicle 102, and/or a set of bolts, clasps, snaps, tie points, or other such physical coupling mechanisms or a combination thereof. The car-top mount 302 further comprises a car-top display 308 that identifies the service 108 (e.g., an illuminated sign displaying the name, type, and/or logo of the service 108 and/or the service provider 106). The car-top mount 302 further comprises a processor 304 and a memory 312, which stores instructions that, when executed by the processor 304, provide an example system 314 that causes the car-top mount 302 to operate in accordance with the techniques presented herein.

The example system 314 comprises a global positioning system (GPS) receiver 316, which communicates with an array of geostationary satellites 118 using a radiofrequency 120 to detect a location 114 of the vehicle 102 during the route 110. The example system 314 further comprises a population density estimator 318, which estimates a population density estimate 212 of a population in a vicinity 208 of the location 114 of the vehicle 102 during the route 110. The example system 314 further comprises a population density reporter 206, which reports the population density estimate 212 to the service provider 106 of the vehicle 102 during the route 110 while providing the service 108. For example the population density reporter 320 may transmit a population density notification 216 to the service provider 106, and/or present a population density warning 214 to the driver 104 of the vehicle 102 as a cautionary and/or safety mechanism. In this manner, the example car-top mount 302 and/or the example system 314 in the example 300 of FIG. 3 facilitate the vehicle 102, the driver 104, and/or the service provider 106 in the navigation of the vehicle 102 along the route 110 while providing the service 108 in accordance with the techniques presented herein.

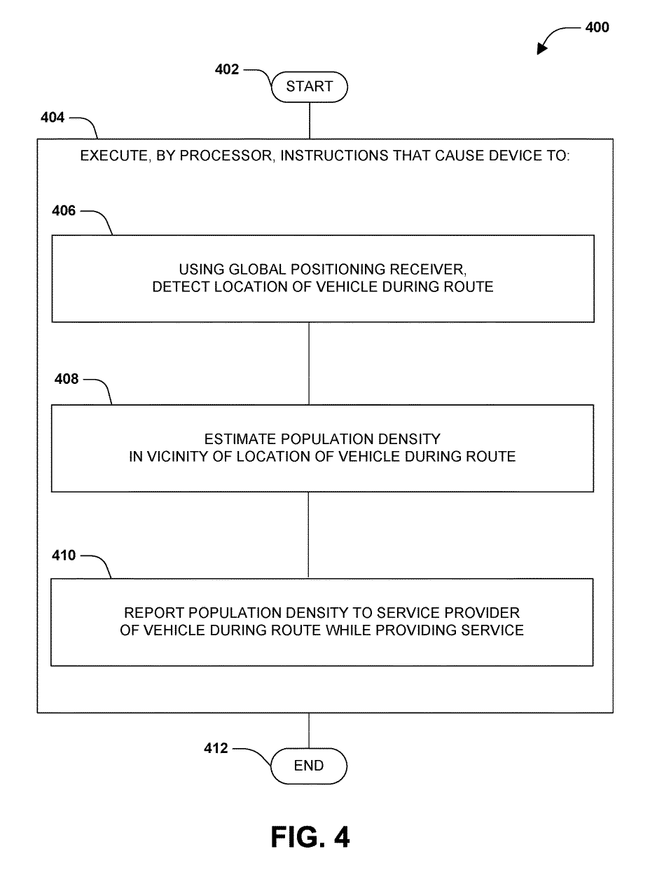

FIG. 4 is an illustration of an example method 400 of evaluating a population density estimate 212 of a population of individuals 210 within a vicinity 208 of a location 114 of a vehicle 102 navigating a route 110 while providing a service 108 of a service provider 106. The example method 400 involves a car-top mount having a processor 304 and a global positioning system (GPS) receiver 316, and may be implemented, e.g., as a set of instructions stored in a memory 312 of the car-top mount 302, such as firmware, system memory, a hard disk drive, a solid-state storage component, or a magnetic or optical medium, wherein the execution of the instructions by the processor 304 causes the car-top mount 302 to perform in accordance with the techniques presented herein.

The example method 400 begins at 402 and involves executing 404 the instructions on the processor 304. In particular, executing 404 the instructions causes the car-top mount 302 to, using the global positioning system receiver 316, detect 406 the location 114 of the vehicle 102 during the route 110. Executing 404 the instructions further causes the car-top mount 302 to estimate 408 a population density estimate 212 of individuals 210 in a vicinity 208 of the location 114 of the vehicle 102 during the route 110. Executing 404 the instructions further causes the car-top mount 302 to report 410 the population density estimate 212 to the service provider 106 of the vehicle 102 during the route 110 while providing the service 108. In this manner, the example method 400 enables the car-top mount 302 to assist the vehicle 102, the driver 104, and/or the service provider 106 in navigating the vehicle 102 along the route 110 in the provision of the service 108 in accordance with the techniques presented herein, and so ends at 412.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

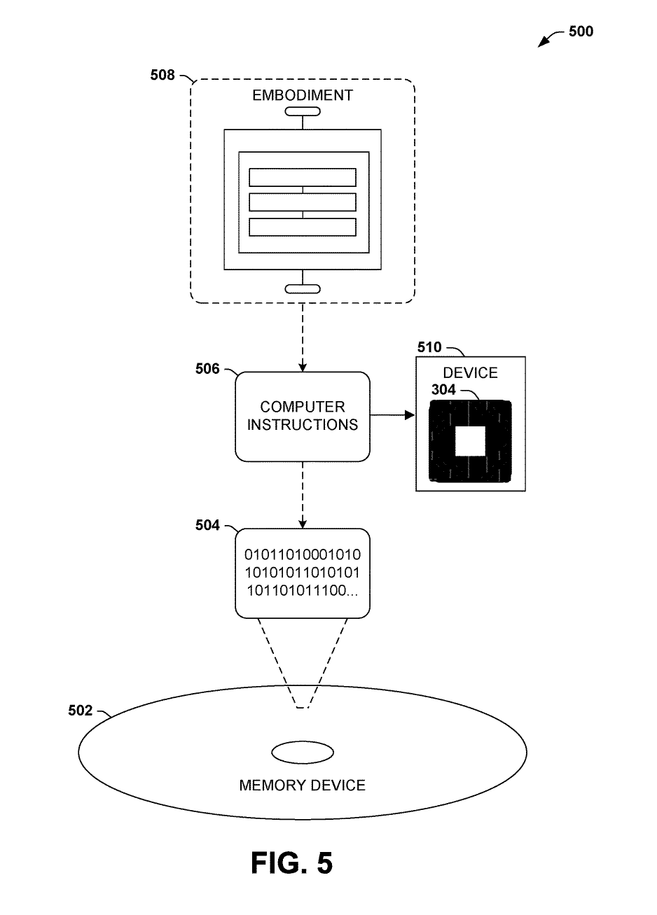

An example computer-readable medium that may be devised in these ways is illustrated in FIG. 5, wherein the implementation 500 comprises a computer-readable memory hardware device 502 (e.g., a CD-R, DVD-R, or a platter of a hard disk drive), on which is encoded computer-readable data 504. This computer-readable data 504 in turn comprises a set of computer instructions 506 that, when executed on a processor 404 of a device 510, cause the device 510 to operate according to the principles set forth herein. For example, the processor-executable instructions 506 may cause a device to assist a user 102 in navigating a route 108 to a destination 106, such as the example system 314 included in the example car-top mount 302 of FIG. 3. As another example, execution of the processor-executable instructions 506 may cause a car-top mount 102 to perform a method of tracking a population density estimate 212 in proximity to the vehicle 102, such as the example method 400 FIG. 4. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example car-top mount 302 of FIG. 3; the example system 314 of FIG. 3; the example method 400 of FIG. 4; and/or the example computer-readable memory device 500 of FIG. 5) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized with many types of vehicles 102, such as cars, bicycles, motorcycles, trucks, buses, aircraft, watercraft, and drones. It is to be appreciated that the term “car-top mount” is used herein to describe a device form factor and/or mounting type of the device with respect to the vehicle 102, and is not provided to limit the types of vehicles with which such car-top mounts 302 are advantageously usable.

As a second variation of this first aspect, the techniques presented herein may be usable with a variety of service 108 provided by a variety of service providers 106, such as the delivery of mail, packages, food, medication, or publications; short- or long-distance freight services; the transportation of individuals, optionally including the individuals 210 comprising the population density estimate 212; and/or emergency services, such as fire, medical, and/or police.

As a third variation of this first aspect, the techniques presented herein may be usable to identify many types of individuals 210 comprising a population density estimate 212, such as pedestrians, cyclists, and/or other vehicles operating near the vehicle 102. Many such variations of the techniques presented herein may be devised by persons of ordinary skill in the art to which the currently presented techniques apply.

E2. Car-Top Mount Integrated Devices

A second aspect that may vary among embodiments of the presented techniques involves the number, types, and/or interoperation of devices integrated with the car-top mount 302 to facilitate the application of the techniques presented herein.

As a first variation of this second aspect, the car-top mount 302 may comprise an integrated antenna. The integrated antenna may be positioned outside the vehicle to receive a global positioning system radiofrequency 120 for the global positioning system receiver 316, and/or a cellular radiofrequency usable with a cellular communication device.

As a second variation of this second aspect, the car-top mount 302 may comprise a rechargeable battery that powers the global positioning system receiver 316, the population density estimator 318, and the population density reporter 320 while the vehicle 102 navigates the route 110 while providing the service 108. For example, the rechargeable battery may comprise a lithium-ion battery that is chargeable when the vehicle 102 is stationary, and that provides power to the elements of the example system 314 of FIG. 3 while the vehicle 102 is in operation. Alternatively or additionally, the car-top mount 302 may comprise a power cord that connects to a power source of the vehicle 102 (e.g., a lighter port, an auxiliary power port, and/or the terminals of the main vehicle battery), and the global positioning system receiver 316, the population density estimator 318, and population density reporter 320 may connect within the car-top mount 302 to the same power source, such that a single connection between the car-top mount 302 and the vehicle power source supplies power to a variety of elements of the example car-top mount 302.

As a third variation of this second aspect, the car-top mount 302 may comprise a magnetic attachment mechanism that removably attach the car-top mount to a top surface of the vehicle. Alternatively or additionally, the car-top mount 302 may comprise a set of bolts, clasps, snaps, tie points, or other such physical coupling mechanisms or a combination thereof.

As a third variation of this second aspect, the car-top mount 302 may comprise a cellular communicator that communicates with the service provider 106 using a cellular radiofrequency, e.g., to transmit the locations 114 of the vehicle 102 and/or the population density notifications 216 while the vehicle 102 is navigating the route 110. Alternatively or additionally, the vehicle 102 may possesses a wireless device comprising a first wireless adapter (e.g., a cellular communicator coupled with a localized wireless communicator, such as a first Bluetooth adapter), and the car-top mount 302 may comprise a second wireless adapter that communicates the population density estimate 212 with the first wireless adapter (e.g., a second Bluetooth adapter that couples with the first Bluetooth adapter to transmit the population density estimate 212, such that the wireless device may further transmit the population density estimate 212 to the service provider 106. Alternatively or additionally, the population density reporter 206 may further comprise a population density memory hardware device that stores the population density estimate 212 for respective locations 114 along the route 110 while the vehicle 102 navigates the route 110 while providing the service 108, and a population density transmitter that transmits the population density estimate 212 for the respective locations 114 along the route 110 when the car-top mount 202 returns to the service provider 106. Many such devices may be integrated with the car-top mount 302 in accordance with the techniques presented herein.

E3. Population Density Estimation and Reporting

A third aspect that may vary among embodiments of the presented techniques involves the manner in which the population density estimator 318 estimates the population density estimate 212 of the vicinity 208 of the location 114 of the vehicle 102, and reports the population density estimate 212 to the service provider 106.

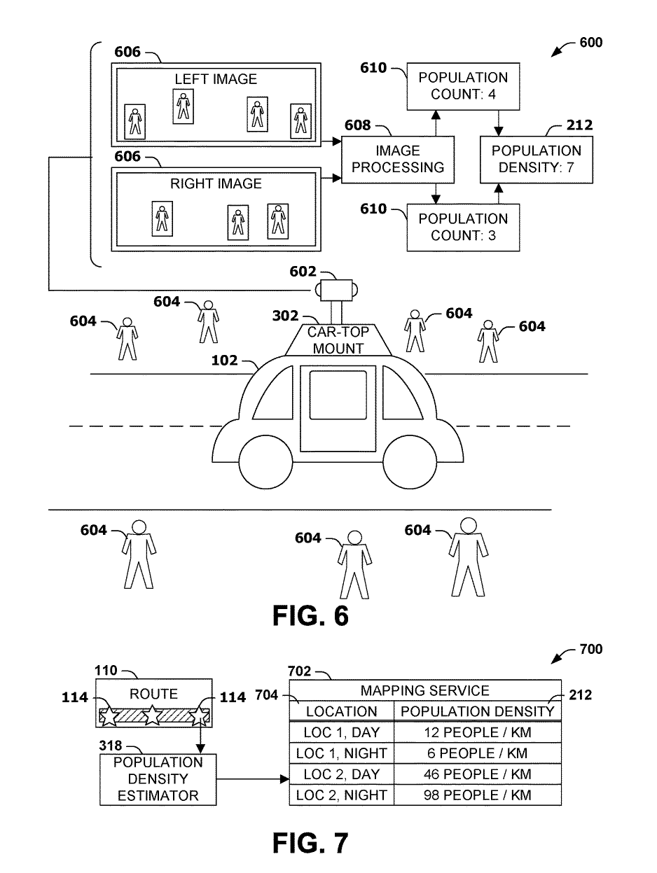

FIG. 6 is an illustration of an example scenario 600 featuring a first variation of this third aspect. In this example scenario 600, a vehicle 102 comprises a car-top mount 302 featuring a camera 602 integrated with the car-top mount 302 that captures one or more images 606 of the vicinity 208 of the location 114 of the vehicle 208. For example, the vehicle 102 may comprise an elevated camera array that captures a first image 606 of a left side of the vehicle 102, and a second image 606 of a right side of the vehicle 102, where within such images 606 may be visible and countable a number of pedestrians 604 within the vicinity 208 of the location 114 of the vehicle 102. The car-top mount 302 may further comprise an image evaluator that applies an image processing technique 608 to the respective images 606 (e.g., a face recognition technique, or an object recognition technique that recognizes individual objects such as cars according to a shape) to count the pedestrians 604 estimate the population density estimate 212 of the vicinity 208 of the location 114 of the vehicle 102. For instance, the image processing 608 may result in a first population count 610 for the left side image 606 indicating the count of pedestrians 604 within visible range of the left side of the vehicle 102, and a second population count 610 for the right side image 606 indicating the count of pedestrians 604 within visible range of the right side of the vehicle 102. The sum of such population counts 610 may provide the population density estimate 212 that is reportable to the service provider 106 in accordance with the techniques presented herein.

FIG. 7 is an illustration of an example scenario 700 featuring a second variation of this third aspect. In this example scenario 700, the population density estimator 318 compares the locations 114 of the vehicle 102 that are detected along the route 110 with a mapping service 702 that stores a database correlating respective locations 704 with projected population densities 212. For example, the mapping service 702 may comprise a database of the estimated and/or typical number of pedestrians 604 that are present within various locations at various times of various days. The mapping service 702 may be collocated with the population density estimator 318 (e.g., a locally stored database in the memory 312 of the car-top mount 302), and/or may be remotely accessible to the population density estimator 318 (e.g., via a cellular radiofrequency). The population density estimator 318 may transmit the location 114 of the vehicle 102 to the mapping service 702 and may receive back a population density estimate 212 for the location 114, optionally specific to a particular time period, such as the time of day (e.g., noon vs. 2:00 pm vs. 10:00 pm) or the day of the week (Saturday vs. Sunday vs. Tuesday).

As a third variation of this third aspect, a car-top mount 202 may transmit and/or utilize the population density estimate 212 in a variety of ways.

As a first such example, the vehicle may further comprise an autonomous driving system, and the reporting the population density estimate 202 may be transmitted to the autonomous driving system to facilitate autonomous driving of the vehicle 102. For example, the autonomous driving system may reduce a driving speed of the vehicle 102 while the population density estimate 212 is above a first threshold (i.e., detecting a highly crowded vicinity 208), and increase the driving speed of the vehicle 102 while the population density estimate 212 is below a second threshold that is below the first threshold (i.e., detecting a sparsely crowded vicinity 208).

As a second such example, the car-top mount 202 may recommend routes of the vehicle 102 to the destination 112 (e.g., to a driver 104 and/or an autonomous driving system), and the car-top mount 202 may, responsive to the population density estimator 204 identifying a population density estimate 212 that is above the first threshold (i.e., detecting a highly crowded vicinity 208), recommend an alternative route of the vehicle 102 to the destination 112 that may present a lower population density estimate 212.

As a third such example, while the vehicle 102 is operated by a driver 104, a car-top mount 202 may, responsive to the population density estimator 204 identifying a population density estimate 212 that is above a first threshold (i.e., detecting a highly crowded vicinity 208), transmit a warning of the population density estimate 212 to the driver 104, e.g., as an audio alert presented over an audio system of the vehicle 102.

As a fourth such example, a car-top mount 202 may estimate a total population density in the vicinity 208 of the respective locations 114 of the vehicle 102 during the route 110 between a departure location and a destination 112 of the route 110 (e.g., a total estimated count of individuals 604 to whom the car-top display 308 was visible while the vehicle 102 was in transit along the route 110). As a further example, the car-top display 308 may present some information at some times, and other information at other times. For example, the car-top display 308 present a first set of information when the population density estimator 204 estimates that a threshold count of individuals have seen a particular set of information, and may then rotate to a second set of information, etc., such that each set of information is visible to approximately a desired count of individuals while the vehicle 102 travels along the route 110.

As a fifth such example, a car-top mount 202 may further detects a departure of the vehicle 112 from a departure location of the route 110, and a service provider notifier may notify the service 108 of the departure of the vehicle 102 from the departure location of the route 110.

As a sixth such example, the global positioning system receiver 116 may further detect an arrival of the vehicle 102 at a destination 112 of the route 110, and a service provider notifier may notify the service provider 106 of the arrival of the vehicle 102 at the destination 112 of the route 110.

As a seventh such example, the global positioning system receiver 116 may further estimate a time of arrival of the vehicle 102 at the destination 112 of the route 110 based at least in part on the population density estimate 212, and a service provider notifier may notify the service provider 106 of the estimated time of arrival of the vehicle 102 at the destination 112 of the route 110. Many such variations of the uses of the population density estimates 212 may be included in variations of the techniques presented herein.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. One or more components may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A car-top mount usable with a vehicle navigating a route while providing a service of a service provider, the car-top mount comprising:
a car-top display that identifies the service;
a global positioning system receiver that detects a location of the vehicle during the route;
a population density estimator that estimates a population density of a population in a vicinity of the location of the vehicle during the route; and
a population density reporter that reports the population density to the service provider of the vehicle during the route while providing the service.

2. The car-top mount of claim 1, wherein the population density of the population is selected from a population density set comprising:
a pedestrian count of pedestrians within the vicinity of the location of the vehicle;
a cyclist count of cyclists within the vicinity of the location of the vehicle; and
a vehicle count of other vehicles within the vicinity of the location of the vehicle.

3. The car-top mount of claim 1, further comprising: an integrated antenna integrated with the car-top mount and positioned outside the vehicle to receive a global positioning system radiofrequency for the global positioning system receiver.

4. The car-top mount of claim 1, further comprising: a rechargeable battery that powers the global positioning system receiver, the population density estimator, and the population density reporter while the vehicle navigates the route while providing the service.

5. The car-top mount of claim 1, further comprising: a magnetic attachment that removably attaches the car-top mount to a top surface of the vehicle.

6. The car-top mount of claim 1, wherein the population density reporter further comprises: a cellular communicator that communicates with the service provider using a cellular radiofrequency.

7. The car-top mount of claim 1, wherein:
the vehicle further possesses a wireless device comprising a first wireless adapter; and
the population density reporter further comprises: a second wireless adapter that communicates the population density estimate with the first wireless adapter.

8. A system for a car-top mount usable with a vehicle navigating a route while providing a service of a service provider, the vehicle comprising a car-top display that identifies the service, and the system comprising:
a global positioning system receiver that detects a location of the vehicle during the route;
a population density estimator that estimates a population density of a population in a vicinity of the location of the vehicle during the route; and
a population density reporter that reports the population density to the service provider of the vehicle during the route while providing the service.

9. The system of claim 8, wherein:
the global positioning system receiver further detects a departure of the vehicle from a departure location of the route; and
the system further comprises: a service provider notifier that notifies the service of the departure of the vehicle from the departure location of the route.

10. The system of claim 8, wherein:
the global positioning system receiver further detects an arrival of the vehicle at a destination of the route; and
the system further comprises: a service provider notifier that notifies the service of the arrival of the vehicle at the destination of the route.

11. The system of claim 10, wherein:
the global positioning system receiver further updates an estimated time of arrival of the vehicle at the route based at least in part on the population density estimate; and
the system further comprises: a service provider notifier that notifies the service of the estimated time of arrival of the vehicle at the destination of the route.

12. The system of claim 8, wherein the population density estimator further comprises:
a camera integrated with the car-top mount that captures an image of a vicinity of the location of the vehicle; and
an image evaluator that evaluates the image of the vicinity of the location of the vehicle to estimate the population density of the vicinity of the location of the vehicle.

13. The system of claim 8, wherein the population density estimator further comprises a wireless communicator that:
wirelessly transmits the location of the vehicle to a mapping service; and
receives, from the mapping service, the population density estimate of the vicinity of the location of the vehicle.

14. The system of claim 8, wherein the population density reporter further comprises:
a population density memory hardware device that stores the population density estimate for respective locations along the route while the vehicle navigates the route while providing the service; and
a population density transmitter that transmits the population density estimate for the respective locations along the route when the car-top mount returns to the service provider.

15. A method of evaluating a population density of a population within a vicinity of a vehicle navigating a route while providing a service of a service provider, the vehicle comprising a car-top display that identifies the service, the method involving a device having a processor and comprising:
executing, by the processor, instructions that cause the device to:
using a global positioning system receiver, detect a location of the vehicle during the route;
estimate a population density in a vicinity of the location of the vehicle during the route; and
report the population density to the service provider of the vehicle during the route while providing the service.

16. The method of claim 15, wherein:
the vehicle further comprises an autonomous driving system; and
reporting the population density further comprises: transmitting the population density estimate in the vicinity of the vehicle to the autonomous driving system to facilitate autonomous driving of the vehicle.

17. The method of claim 15, wherein facilitating the autonomous driving of the vehicle further comprises:
reducing a driving speed of the vehicle while the population density estimate is above a first threshold; and
increasing the driving speed of the vehicle while the population density estimate is below a second threshold that is below the first threshold.

18. The method of claim 15, wherein executing the instructions further causes the device to:
recommend the route of the vehicle to the destination; and
responsive to the population density estimator identifying a population density estimate that is above a first threshold, recommend an alternative route of the vehicle to the destination having a lower population density estimate.

19. The method of claim 15, wherein:
the vehicle is operated by a driver; and
executing the instructions further comprises the device to, responsive to the population density estimator identifying a population density estimate that is above a first threshold, transmit a warning of the population density estimate to the driver.

20. The method of claim 15, wherein estimating the population density in the vicinity of the location of the vehicle during the route further comprises: estimating a total population density in the vicinity of the location of the vehicle during the route between a departure location and a destination of the route.
